(19) United States
(12) Patent Application Publication
(10) Pub. No.: US 2011/0287288 A1
(43) Pub. Date: Nov. 24, 2011

(54) NONAQUEOUS ELECTROLYTE SECONDARY BATTERY AND NONAQUEOUS ELECTROLYTE SECONDARY BATTERY FABRICATING METHOD

(76) Inventors: Yasuhiko Hina, Hyogo (JP); Yoshiyuki Muraoka, Osaka (JP)

(21) Appl. No.: 12/525,643

(22) PCT Filed: Feb. 2, 2009
(86) PCT No.: PCT/JP2009/000383

§ 371 Date: Aug. 3, 2009

(51) Int. Cl. H01M 4/70; H01M 10/05; H01M 4/04; H01M 4/66

(52) U.S. Cl. 429/94; 427/58

(57) ABSTRACT

A nonaqueous electrolyte secondary battery includes an electrode group (8) including a positive electrode (4) in which a positive electrode material mixture layer (4B) is provided on a positive electrode current collector (4A), a negative electrode (5) in which a negative electrode material mixture layer (5B) is provided on a negative electrode current collector (5A), and a porous insulating film (6). The positive electrode (4) and the negative electrode (5) are wound with the porous insulating layer (6) interposed. The positive electrode material mixture layer (4B) is provided on at least one of opposite surfaces of the positive electrode current collector (4A) located inside in a radial direction of the electrode group (8). The positive electrode material mixture layer (4B) has a porosity of 20% or lower. Where η is a thickness of the positive electrode material mixture layer (4B) provided on the surface located inside in the radial direction of the electrode group (8) of the surfaces of the positive electrode current collector (4A), ρ is a minimum radius of curvature of the positive electrode (4), and ε is a tensile extension in a winding direction of the positive electrode (4), ε≧η/ρ is satisfied.

### TECHNICAL FIELD

The present disclosure relates to nonaqueous electrolyte secondary batteries and nonaqueous electrolyte secondary battery fabricating methods, and particularly relates to a high-capacity nonaqueous electrolyte secondary battery and its fabricating method.

### BACKGROUND ART

To meet recent demands for use on vehicles in consideration of environmental issues or for employing DC power supplies for large tools, small and lightweight secondary batteries capable of performing rapid charge and large-current discharge have been required. Examples of typical secondary batteries satisfying such demands include a nonaqueous electrolyte secondary battery.

The nonaqueous electrolyte secondary battery (hereinafter simply referred to as a “battery”) includes as a power generating element, an electrode group in which a positive electrode and a negative electrode are wound with a porous insulating layer interposed. The power generating element is disposed together with an electrolyte in a battery case made of metal, such as stainless, nickel-plated iron, aluminum, or the like. The battery case is sealed with a lid plate.

In the positive electrode, a positive electrode active material is provided on a sheet-shaped or foil-shaped positive electrode current collector. Examples of materials of the positive electrode active material include lithium cobalt composite oxides and the like electrochemically reacting with lithium ions reversibly. In the negative electrode, a negative electrode active material is provided on a sheet-shaped or foil-shaped negative electrode current collector. Examples of materials of the negative electrode active material include carbon and the like inserting and extracting lithium ions. The porous insulating layer retains the electrolyte, and prevents a short circuit from occurring between the positive electrode and the negative electrode. The electrolyte employs an aprotic organic solvent in which lithium salt such as LiClO₄ or LiPF₆ is dissolved.

Incidentally, high-capacity nonaqueous secondary batteries are being demanded in these days. One of methods for increasing the capacity of a nonaqueous electrolyte secondary battery may be increasing the loading density of an active material in a material mixture layer.

Patent Document 1: Japanese Unexamined Patent Application Publication No. 05-182692.

### SUMMARY

### Problems that the Invention is to Solve

However, it was found that an increased loading density of an active material in a material mixture layer can lower the manufacturing yield of a nonaqueous electrolyte secondary battery.

The present invention has been made in view of the foregoing, and its objective is to achieve high capacity of a nonaqueous electrolyte secondary battery with no lowering of a manufacturing yield accompanied.

### Means for Solving the Problems

A nonaqueous electrolyte secondary battery according to the present invention includes an electrode group including a positive electrode in which a positive electrode material mixture layer is provided on a positive electrode current collector, a negative electrode in which a negative electrode material mixture layer is provided on a negative electrode current collector, and a porous insulating film, where the positive electrode and the negative electrode are wound with the porous insulating layer interposed. The positive electrode material mixture layer is provided on at least one of opposite surfaces of the positive electrode current collector located inside in a radial direction of the electrode group. The positive electrode material mixture layer has a porosity of 20% or lower, and ε≧η/ρ is satisfied where η is a thickness of the positive electrode material mixture layer provided on the surface located inside in the radial direction of the electrode group of the surfaces of the positive electrode current collector, ρ is a minimum radius of curvature of the positive electrode, and ε is a tensile extension in a winding direction of the positive electrode.

In the above configuration, even when the positive electrode material mixture layers become hard due to a reduction in porosity of the positive electrode material mixture layers, the electrode group of wound type (an electrode group in which a positive electrode and a negative electrode are wound with a porous insulating layer interposed) can be fabricated without breaking the positive electrode current collector.

Here, the term “tensile extension in a winding direction of a positive electrode” in the present description is a value measured in accordance with the following method. First, a sample positive electrode (having a width of 15 mm and a length in the winding direction of 20 mm) is prepared. Next, one end in the winding direction of the sample positive electrode is fixed, and the other end in the winding direction of the sample positive electrode is pulled in the winding direction at a speed of 20 mm/min. The length in the winding direction of the sample positive electrode immediately before breakage is measured. Then, from this length and the length in the winding direction of the sample positive electrode before pulling, the tensile extension in the winding direction of the positive electrode is calculated.

The term, “porosity of a positive electrode material mixture layer” in the present description is a ratio of the total volume of pores present in the positive electrode material mixture layers to the total volume of the positive electrode material mixture layers, and is calculated by using the following equation.

Porosity=1−(volume of components 1+volume of components 2+volume of components 3)/(volume of positive electrode material mixture layers)

Here, the volume of positive electrode material mixture layers is calculated in such a manner that a positive electrode is cut to have a predetermined dimension after the thickness of the positive electrode material mixture layer is measured under a scanning electron microscope.

The components 1 are components of a positive electrode material mixture which are dissoluble in acid. The components 2 are components of the positive electrode material mixture which are insoluble in acid and have thermal volatility. The components 3 are components of the positive electrode material mixture which are insoluble in acid and have no thermal volatility. The volumes of the components 1 to 3 are calculated in the following methods.

First of all, a positive electrode cut to have a predetermined dimension is separated into a positive electrode current collector and positive electrode material mixture layers. Then, the weight of the positive electrode material mixture is measured. Subsequently, the positive electrode material mixture is dissolved in acid to separate into components dissolved in the acid and components not dissolved in the acid. The components dissolved in the acid are subjected to a qualitative and quantitative analysis using a fluorescent X-ray and to a structure analysis by X-ray diffraction. From the result of the qualitative and quantitative analysis and the result of the structure analysis, the lattice constant and the molecular weight of the components are calculated. Thus, the volume of the components 1 can be calculated.

Referring on the other hand to the components not dissolved in the acid, the weight of the components is measured first. Then, the components are subjected to a qualitative analysis using gas chromatography/mass spectrometry, and then are subjected to a thermogravimetric analysis. This volatilizes components having thermal volatility from the component not dissolved in the acid. However, not all components having thermal volatility may be volatized from the components not dissolved in the acid by the termiogravimetric analysis. For this reason, it is difficult to calculate the weight of the components having thermal volatility of the components not dissolved in the acid from the result of the thermogravimetric analysis (the result of the thermogravimetric analysis on the sample). In view of this, a reference sample of the components having thermal volatility of the components not dissolved in the acid is prepared and subjected to thermogravimetric analysis (from the result of the qualitative analysis using gas chromatography/mass spectrometry, the compositions of the components having thermal volatility of the components not dissolved in the acid have been known). Then, from the result of the thermogravimetric analysis on the sample and the result of the thermogravimatric analysis on the reference sample, the weight of the components having thermal volatility of the components not dissolved in the acid is calculated. From the weight thus calculated and the true density of the components having thermal volatility of the components not dissolved in the acid, the volume of the components 2 is calculated.

Once the weight of the components having thermal volatility of the components not dissolved in the acid is known, the weight of the components having no thermal volatility of the components not dissolved in the acid can be obtained from the result of the thermogravimetric analysis on the sample and the weight of the sample. From the weight thus obtained and the true specific gravity of the components having no thermal volatility of the components not dissolved in the acid, the volume of the components 3 is calculated.

In a preferable example embodiment described later, the minimum radius p of curvature of the positive electrode is a radius of curvature of a part of the positive electrode material mixture layer forming an innermost surface of the electrode group. In the nonaqueous electrolyte secondary battery according to the present invention, the tensile extension c in the winding direction of the positive electrode is preferably equal to or higher than 2%.

In a preferable example embodiment described later, the positive electrode is obtained by applying onto a surface of the positive electrode current collector and drying positive electrode material mixture slurry containing a positive electrode active material and then performing heat treatment after rolling on the positive electrode current collector having the surface on which the positive electrode active material is provided. In this case, if the positive electrode current collector is made of aluminum containing iron, it is possible to reduce the temperature or the time period of the heat treatment after rolling, which is necessary for setting the tensile extension ε in the winding direction of the positive electrode to be equal to or larger than η/ρ(ε≧η/ρ).

In the nonaqueous electrolyte secondary battery according to the present invention, preferably, the positive electrode material mixture layer contains a positive electrode active material and a conductive agent, and a ratio of a volume that the conductive agent occupies in the positive electrode material mixture layer to a volume that the positive electrode active material occupies in the positive electrode material mixture layer is equal to or higher than 1% and equal to or lower than 6%. This can prevent a reduction in cycle characteristic (ability to maintain the initial battery capacity after repetition of a charge/discharge cycle) caused by a reduction in porosity of the positive electrode material mixture layer. The term, “volume that the conductive agent occupies in the positive electrode material mixture layer” and “volume that the positive electrode active material occupies in the positive electrode material mixture layer” in the present description adheres to the above method for calculating the porosity.

Referring to a method for fabricating such a nonaqueous electrolyte secondary battery, the positive electrode is fabricated by (a) applying onto a surface of the positive electrode current collector electrode material mixture slurry containing a positive electrode active material, and then drying it; (b) rolling the positive electrode current collector having the surface on which the positive electrode active material is provided; and (c) performing, after (b), heat treatment on the rolled positive electrode current collector at a temperature equal to or higher than a softening temperature of the positive electrode current collector. This can set the tensile extension ε in the winding direction of the positive electrode to be equal to or larger than η/ρ(ε≧η/ρ). Thus, even with a reduced porosity of the positive electrode material mixture layers, the electrode group of wound type can be fabricated without breaking the positive electrode current collector.

### Advantages

According to the present invention, the capacity of a nonaqueous electrolyte secondary battery can be increased without lowering a manufacturing yield.

### BRIEF DESCRIPTION OF THE DRAWINGS

FIG. 1 is a table indicating a result obtained by checking the presence or absence of breakage of positive electrode current collectors with the porosity of the positive electrode material mixture layers varied.

FIGS. 2(a) and 2(b) are cross-sectional views of parts in the longitudinal direction of positive electrodes, where FIG. 2(a) is a cross-sectional view of a positive electrode in a non-wound state, and FIG. 2(b) is a cross-sectional view of a positive electrode in a wound state.

FIGS. 3(a) and 3(b) are cross-sectional views of parts in the longitudinal direction of positive electrodes, where FIG. 3(a) is a cross-sectional view of a positive electrode including positive electrode material mixture layers having a high porosity, and FIG. 3(b) is a cross-sectional view of a positive electrode including positive electrode material mixture layers having a low porosity.

FIGS. 4(a) and 4(b) are cross-sectional views of positive electrodes, where FIG. 4(a) is a cross-sectional view showing a state in which a positive electrode not subjected to heat treatment after rolling is pulled in the winding direction, and FIG. 4(b) is a cross-sectional view showing a state in which a positive electrode subjected to heat treatment after rolling is pulled in the winding direction.

FIG. 5 is a table indicating results in the case where batteries were fabricated using positive electrodes in which positive electrode material mixture layers containing LiCoO₂ as a positive electrode active material are formed on a positive electrode current collector made of aluminum, where the results were obtained by measuring the tensile extensions of the positive electrodes subjected to heat treatment after rolling with conditions of the heat treatment changed.

FIG. 6 is a cross-sectional view schematically showing a configuration of a nonaqueous electrolyte secondary battery according to one example embodiment of the present invention.

FIG. 7 is an enlarged cross-sectional view schematically showing an electrode group 8 in one example embodiment of the present invention.

FIG. 8 is a cross-sectional view for explaining η and ρ in one example embodiment of the present invention.

FIG. 9 is a table indicating results obtained by checking easiness of causing a positive electrode current collector to be broken, with the tensile extension in the winding direction of positive electrodes varied, where η/ρ=1.71 (%).

FIG. 10 is a table indicating results obtained by checking easiness of causing a positive electrode current collector to be broken, with the tensile extension in the winding direction of positive electrodes varied, where η/ρ=2.14 (%).

FIG. 11 is a table indicating results obtained by checking easiness of causing a positive electrode current collector to be broken, with the tensile extension in the winding direction of positive electrodes varied, where η/ρ=2.57 (%).

FIG. 12 is a table indicating results obtained by measuring the porosity of positive electrode material mixture layers, with the pressure at rolling varied.

FIG. 13 is a table indicating results obtained by measuring cycle characteristics and battery capacities, with the occupied volume of a conductive agent in positive electrode material mixture layers varied.

### DESCRIPTION OF CHARACTERS

1 battery case
2 sealing plate
3 gasket
4 positive electrode
4A positive electrode current collector
4B positive electrode material mixture layer
4a positive electrode lead
5 negative electrode
5A negative electrode current collector
5B negative electrode material mixture layer
5a negative electrode lead
6 porous insulating layer
8 electrode group
9 crack
44 positive electrode
44A positive electrode current collector
44B positive electrode material mixture layer
45 inner peripheral surface
46 inner peripheral surface
49 crack
144 positive electrode
144A positive electrode current collector
144B positive electrode material mixture layer
145 inner peripheral surface
146 inner peripheral surface

### BEST MODE FOR CARRYING OUT THE INVENTION

Prior to describing example embodiments of the present invention, the circumstances that led the present invention to be achieved will be described.

As described above, high-capacity nonaqueous electrolyte secondary batteries have been demanded. To meet this demand, an increase in loading density of active materials in material mixture layers are being examined.

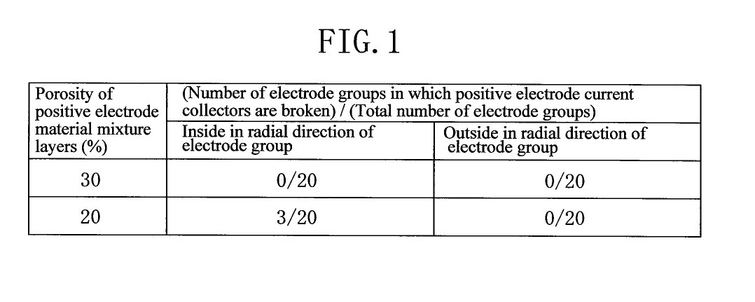

Excessively high loading densities of negative electrode active materials in negative electrode material mixture layers significantly reduce acceptance of lithium ions in negative electrodes to deposit lithium on the surfaces of the negative electrodes as metal, thereby reducing safety of nonaqueous electrolyte secondary batteries. This is a known problem. On the other hand, an increase in loading density of positive electrode active materials in positive electrode material mixture layers is not considered to cause such a problem. In view of this, the present inventors fabricated an electrode group of wound type by using a positive electrode including positive electrode material mixture layers whose positive electrode active material has a loading density higher than the conventional loading density (in other words, by using a positive electrode whose positive electrode material mixture layers have a porosity lower than the conventional porosity). The result is indicated in FIG. 1. As indicated in FIG. 1, it was found that, as the porosity of the positive electrode material mixture layers is decreased more than the conventional porosity (the porosity of conventional positive electrode material mixture layers is around 30%), the positive electrode current collectors tend to be broken in winding, starting from around 20% porosity of the positive electrode material mixture layers. Further, though not indicated in FIG. 1, the lower than 20% the porosity of the positive electrode material mixture layers becomes, the more easily the positive electrode tends to be broken in winding. Additionally, positive electrode groups including broken positive electrodes were examined, and it was found that breakage of the positive electrode current collectors concentrated at parts located inside in the radial direction of the electrode groups, as indicated in FIG. 1. Regarding these results, the present inventors considered the following.

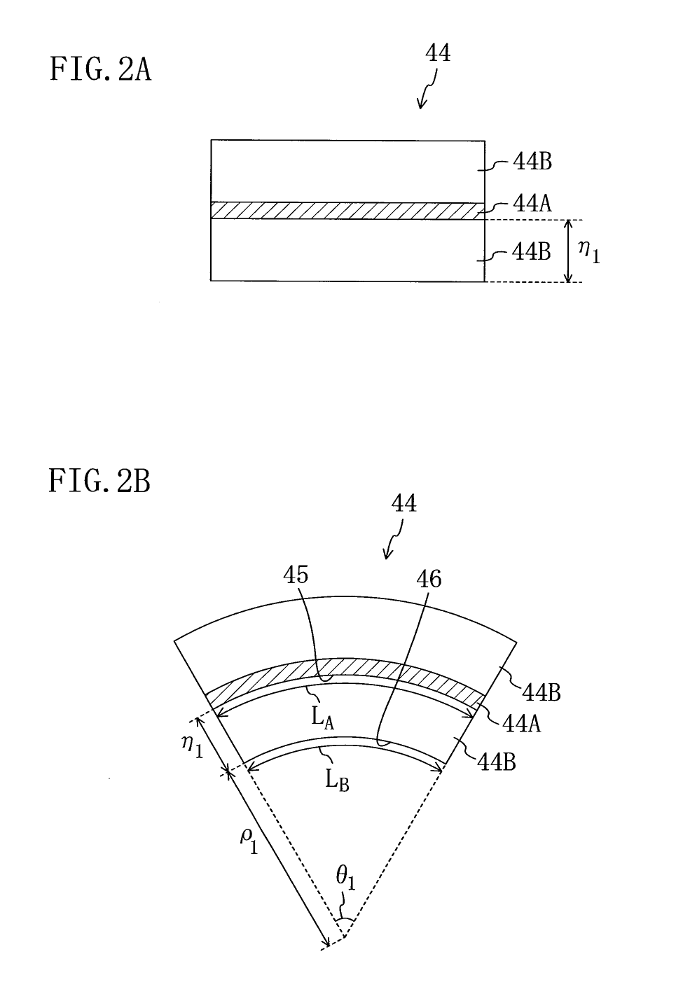

FIGS. 2(a) and 2(b) are cross-sectional views of parts in the longitudinal direction of positive electrodes 44, where FIG. 2(a) is a cross-sectional view of a positive electrode 44 in a non-wound state, and FIG. 2(b) is a cross-sectional view of a positive electrode 44 in a wound state (a part of a positive electrode constituting an electrode group of wound type).

When the positive electrode 44 shown in FIG. 2(a) is wound so that one positive electrode material mixture layer 44B of two positive electrode material mixture layers 44B is located inside, a tensile stress acts on a positive electrode current collector 44A and the outside positive electrode material mixture layer (a positive electrode material mixture layer formed on one of the surfaces of the positive electrode current collector 44A located outside in the radial direction of the electrode group of wound type) 44B. For example, as shown in FIG. 2(b), where η₁ is a thickness of the inside positive electrode material mixture layer 44B (a positive electrode material mixture layer formed on one surface (an inner peripheral surface 45) of the surfaces of the positive electrode current collector 44A located inside in the radial direction of the electrode group of wound type), ρ₁ is a radius of curvature of an inner peripheral surface 46 of the inside positive electrode material mixture layer 44B, and θ₁ is a central angle, the length (L_{A}) in the winding direction of an inner peripheral surface 45 of the positive electrode current collector 44A is

L_{A}=(ρ₁+η₁)θ₁ (Expression 1).

The length (L_{B}) in the winding direction of an inner peripheral surface 46 of the inside positive electrode material mixture layer 44B is

L_{B}=ρ₁θ₁ (Expression 2).

Accordingly, when the positive electrode 44 shown in FIG. 2(a) is wound, the positive electrode current collector 44A extends in the winding direction more than the inside positive electrode material mixture layer 44B by

L_{A}−L_{B}=(ρ₁+η₁)θ₁−ρ₁θ₁=η₁θ₁ (Expression 3).

The ratio (L_{A}−L_{B})/L_{B}) is

(L_{A}−L_{B})/L_{B}=η₁θ₁/ρ₁ƒ₁=η₁/ρ₁ (Expression 4).

Since ρ₁ is smaller in the inside than in the outside in the radial direction of the electrode group, the ratio ((L_{A}−L_{B})/L_{B}) is larger in the inside than in the outside in the radial direction of the electrode group. Accordingly, in the outside in the radial direction of the electrode group, even if the positive electrode current collector 44A cannot extend so much in the winding direction, an electrode group of wound type can be fabricated without breaking the positive electrode current collector 44A. On the other hand, in the inside in the radial direction of the electrode group, if the positive electrode current collector 44A cannot extend enough, it is difficult to fabricate a electrode group of wound type without breaking the positive electrode current collector 44A. As a result, breakage of the positive electrode current collector 44A might concentrate on the inside in the radial direction of the electrode group.

However, the above consideration can explain only the reason that positive electrode current collectors tend to be broken in winding as the radius of curvature becomes small, and cannot explain the reason that positive electrode current collectors tend to be broken in winding as the porosity of positive electrode material mixture layers is reduced. Then, the present inventors examined various phenomena caused by reducing the porosity of positive electrode material mixture layers, and reached the conclusion that the reduction in porosity of positive electrode material mixture layers hardens the positive electrode material mixture layers, which might cause a tendency to cause positive electrode current collectors to be broken in winding.

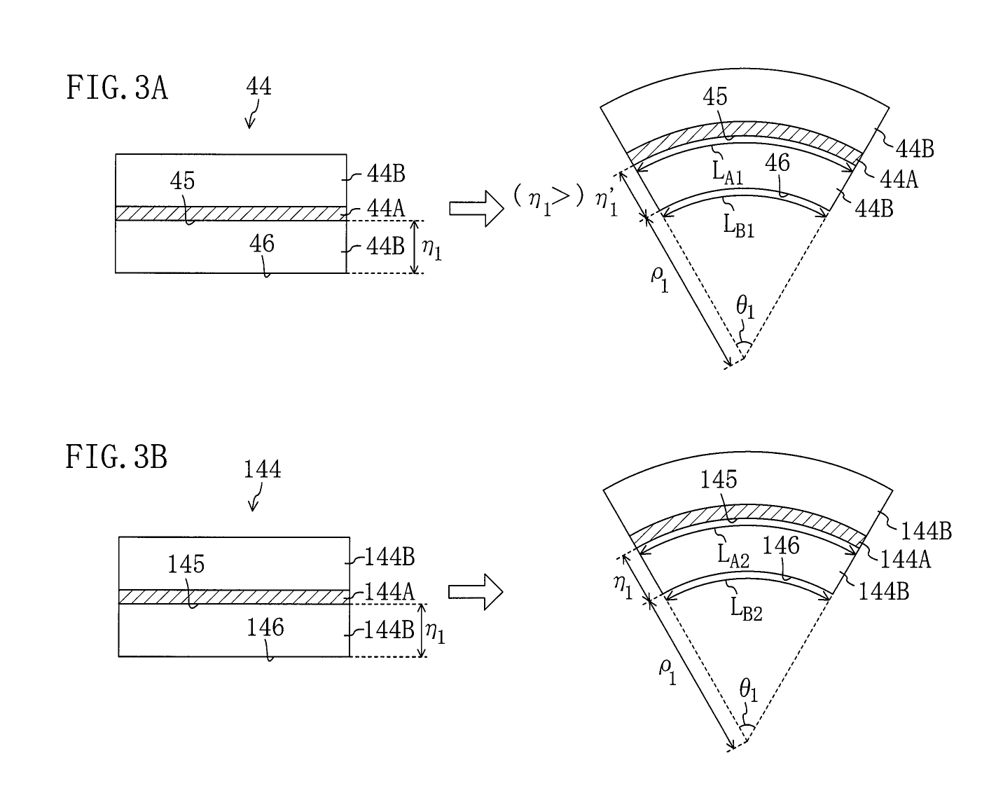

FIGS. 3(a) and 3(b) are cross-sectional views of parts in the longitudinal direction of positive electrodes 44, 144, where FIG. 3(a) is a cross-sectional view of the positive electrode 44 whose positive electrode material mixture layers 44B, 44B have a high porosity, and FIG. 3(b) is a cross-sectional view of the positive electrode 144 whose positive electrode material mixture layers 144B, 144B have a low porosity. In both FIGS. 3(a) and 3(b), the left from the arrows shows the positive electrodes 44, 144 in non-wound states, and the right from the arrows shows the positive electrodes 44, 144 in wound states.

When the positive electrodes 44, 144 are wound, a tensile stress acts on the positive electrode current collectors 44A, 144A and the outside positive electrode material mixture layers 44B, 144B, as described above, while a compressive stress acts on the inside positive electrode material mixture layers 44B, 144B. In the case where the positive electrode material mixture layers 44B, 44B have a high porosity (for example, where the porosity of the positive electrode material mixture layers 44B, 44B is about 30%), winding the positive electrode 44 contracts the inside positive electrode material mixture layer 44B in the thickness direction of the positive electrode 44. That is, the thickness (η₁′) of the inside positive electrode material mixture layer 44B after winding is smaller than the thickness (η₁) of the inside positive electrode material mixture layer 44B before winding (η₁′<η₁). Accordingly, it is sufficient that the length (L_{AI}) in the winding direction of the inner peripheral surface 45 of the positive electrode current collector 44A can extend to be longer than the length (L_{B1}) in the winding direction of the inner peripheral surface 46 of the inside positive electrode material mixture layer 44B only by

L_{A1}−L_{B1}=L_{B1}·(η₁′/ρ₁)<L_{B1}·(η₁/ρ₁) (Expression 5)

On the other hand, in the case where the positive electrode material mixture layers 144B, 144B have a low porosity (for example, where the porosity of the positive electrode material mixture layers 144B, 144B is 20% or lower), the inside positive electrode material mixture layer 144B is harder than the inside positive electrode material mixture layer 44B. Accordingly, even when the compressive stress acts on the inside positive electrode material mixture layer 144B by winding, the inside positive electrode material mixture layer 144B contracts little in the thickness direction of the positive electrode 144. For this reason, the length (L_{A2}) in the winding direction of the inner peripheral surface 145 of the positive electrode current collector 144A must extend to be longer than the length (L_{B2}) in the winding direction of the inner peripheral surface 146 of the inside positive electrode material mixture layer 144B by

L_{A2}−L_{B2}=L_{B2}·(η₁/ρ₁) (Expression 6).

Comparison between Expression 5 and Expression 6 comes to the conclusion that, unless the positive electrode current collector 144A extends more than the positive electrode current collector 44A in the winding, it is broken in winding.

One of methods for preventing the positive electrode current collector 144A from being broken in winding may be removing some amount of the positive electrode active material and the like from the positive electrode material mixture layers 144B in winding. However, removing some amount of the positive electrode active material and the like from the positive electrode material mixture layers 144B reduces the battery capacity of the fabricated battery when compared with that at design, or causes the positive electrode active material and the like removed from the positive electrode material mixture layers 144B to break the porous insulating layer, thereby causing deficiencies, such as occurrence of the internal short circuit. For this reason, winding is carried out so that active materials and the like will not be removed from material mixture layers. Therefore, the present inventors have considered that, as a method for preventing the positive electrode current collector 144A from being broken in winding, the method of removing the positive electrode active material and the like from the positive electrode material mixture layers 144B in winding is not favorable, and selection of a method using a positive electrode current collector capable of sufficiently extending in the winding direction may be favorable.

Further, the present inventors paid particular attention to the fact that positive electrode material mixture layers are formed on the surfaces of a positive electrode current collector in a positive electrode, and considered that even with a positive electrode current collector capable of sufficiently extending in the winding direction, unless positive electrode material mixture layers are formed so as to sufficiently extend in the winding direction, it is difficult to suppress breakage of the positive electrode current collector in wining. In other words, the present inventors concluded that sufficient extension of a positive electrode in the winding direction can increase the battery capacity of a nonaqueous electrolyte secondary battery with breakage of a positive electrode current collector in winding suppressed.

Incidentally, one of the applicants of this application discloses a method for increasing the tensile extension of a positive electrode in Japanese Patent Application No. 2007-323217 (corresponding to PCT/JP2008/002114).

Specifically, first, positive electrode material mixture slurry containing a positive electrode active material, a conductive agent, and a binder is applied onto a positive electrode current collector, and is dried. Thus, a positive electrode current collector having surfaces on which the positive electrode active material, the conductive agent, and the like are provided is fabricated. Next, this positive electrode current collector (the current collector having the surfaces on which the positive electrode active material, the conductive agent, and the like are provided) is rolled, and then is subjected to heat treatment at a predetermined temperature. Thus, when heat treatment at the predetermined temperature is performed, after rolling, on the positive electrode current collector having surfaces on which the positive electrode active material, the conductive agent, and the like are provided (hereinafter, simply referred to as “performing heat treatment after rolling,” “heat treatment after rolling,” or the like), the tensile extension of the positive electrode can be increased more than that before the heat treatment.

The mechanism that can increase the tensile extension of a positive electrode by heat treatment after rolling more than that before the heat treatment might be as follows.

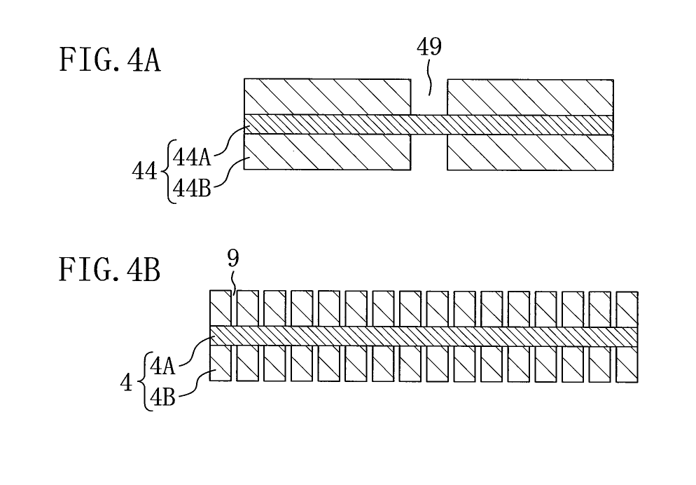

FIGS. 4(a) and 4(b) are cross-sectional views of positive electrodes, where FIG. 4(a) is a cross-sectional view showing a state in which a positive electrode not subjected to heat treatment after rolling is pulled in the winding direction, and FIG. 4(b) is a cross-sectional view showing a state in which a positive electrode subjected to heat treatment after rolling is pulled in the winding direction.

The positive electrode material mixture layers are formed on the surfaces of the positive electrode current collector, and therefore, the tensile extension of the positive electrode is not defined by only the inherent tensile extension of the positive electrode current collector itself. In general, the tensile extension of the positive electrode material mixture layers is lower than that of the positive electrode current collector. Accordingly, when the positive electrode not subjected to heat treatment after rolling is extended as shown in FIG. 4(a), the positive electrode 44 is broken at the same time when a large crack 49 occurs in the positive electrode material mixture layers 44B. A factor of this might be that a tensile stress in the positive electrode material mixture layers 44B increases as the positive electrode 44 is extended, and in turn, the increased tensile stress is applied intensively to a portion of the positive electrode current collector 44A where the large crack 49 occurs, thereby breaking the positive electrode current collector 44A.

In contrast, when a positive electrode 4 subjected to heat treatment after rolling is extended, while multiple minute cracks 9 occur in positive electrode material mixture layers 4B, the positive electrode, in which a positive electrode current collector 4A is softened, continues to extend (FIG.4(b)). In the end, the positive electrode 4 is broken. The factor of this might be as follows. Since a tensile stress applied to the positive electrode current collector 4A is dispersed by occurrence of the multiple minute cracks 9, crack 9 occurrence in the positive electrode material mixture layers 4B influences little the current collector 4A. Therefore, the positive electrode 4 continues to extend up to a given length without being broken at the same time when the cracks 9 occur. Then, the positive electrode current collector 4A is broken at the time the tensile stress reaches a given value (a value approximate to the inherent tensile extension of the current collector 4A).

The tensile extension of a positive electrode obtained by heat treatment after rolling varies depending on the materials of a positive electrode current collector and a positive electrode active material, or conditions for the heat treatment after rolling. In a positive electrode, for example, in which a positive electrode material mixture layers containing LiCoO₂ as a positive electrode active material is formed on a positive electrode current collector made of aluminum, heat treatment at a temperature of 200° C. or higher (for 180 seconds) after rolling can increase the tensile extension of the positive electrode to 3% or more.

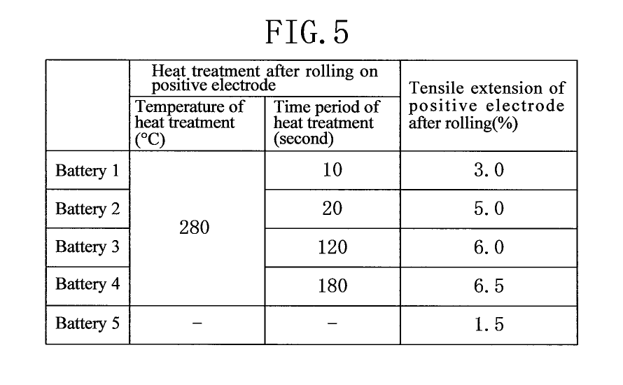

FIG. 5 is a table indicating tensile extensions of positive electrodes measured with the conditions for the heat treatment after rolling varied, where batteries were fabricated using a positive electrode in which positive electrode material mixture layers containing LiCoO₂ as a positive electrode active material are formed on a positive electrode current collector containing 1.2 wt % or more iron with respect to aluminum. Here, positive electrodes of Batteries 1 to 4 were subjected to, after rolling, heat treatment at a temperature of 280° C. for time periods of 10 seconds, 20 seconds, 120 seconds, and 180 seconds, respectively. Battery 5 is a battery not subjected to heat treatment after rolling.

As indicated in FIG. 5, while the tensile extension of the positive electrode of Battery 5 not subjected to heat treatment after rolling is 1.5%, the tensile extensions of the positive electrodes of Batteries 1 to 4 subjected to the heat treatment after rolling are 3 to 6.5%. From this, it is understood that the tensile extensions of the positive electrodes of Batteries 1 to 4 are greater than the tensile extension of the positive electrode of Battery 5.

Further examination by one of the applicants of this application confirmed the followings. Even when the temperature of heat treatment after rolling is lower than that indicated in FIG. 5 ((the softening temperature of a positive electrode current collector)≦(a temperature of heat treatment after rolling)<(the melting temperature of a binder contained in positive electrode material mixture layers)), or even when the time period of heat treatment after rolling is shorter than that indicated in FIG. 5 (e.g., in a range equal to or longer than 0.1 seconds and equal to or shorter than several minutes), the tensile extension of a positive electrode can be set to a desired value.

In sum, the present inventors found a deficiency that, with positive electrode material mixture layers having a low porosity, a positive electrode current collector tends to be broken in winding. As one of factors causing the deficiency, the present inventors considered that, as the porosity of the positive electrode material mixture layers is reduced, the positive electrode material mixture layers become hard to be compressed little in the thickness direction of the positive electrode, thereby breaking the positive electrode current collector unless the positive electrode current collector extends so as to satisfy Expression 4. In view of this, the present inventors considered that sufficient extension in the winding direction of the positive electrode current collector can suppress breakage of the positive electrode current collector in winding even if the porosity of positive electrode material mixture layers is reduced. Further, they considered, with particular attention paid to the fact that positive electrode material mixture layers are formed on the surfaces of a positive electrode current collector in a positive electrode, that sufficient extension in the winding direction of the positive electrode can suppress breakage of the positive electrode current collector in winding even when the porosity of the positive electrode material mixture layers is reduced. Then, the present inventors reached the conclusion that fabrication of a positive electrode according to the method disclosed in the description of the aforementioned application, that is, by heat treatment at a predetermined temperature after rolling on a positive electrode current collector having surfaces provided with a positive electrode active material) can suppress breakage of the positive electrode current collector in winding even when the porosity of positive electrode material mixture layers is 20% or lower. As a result, the present invention was achieved. One example embodiment of the present invention will be described below with reference to the drawings. The present invention is not limited to the following example embodiment. As to a configuration of nonaqueous electrolyte secondary batteries referred to in the present example embodiment, the configuration described in the description of the aforementioned application filed by the present applicant can be applied.

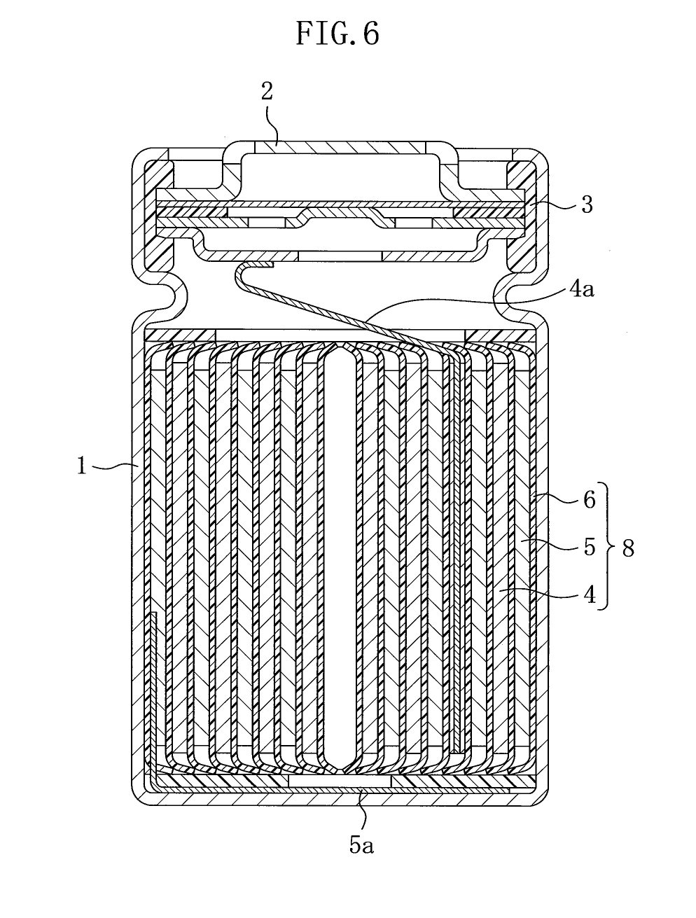

FIG. 6 is a cross-sectional view schematically showing a configuration of a nonaqueous electrolyte secondary battery in one example embodiment of the present invention.

As shown in FIG. 6, in a nonaqueous electrolyte secondary battery according to the present example embodiment, an electrode group 8, in which a positive electrode 4 and a negative electrode 5 are wound with a porous insulating layer 6 interposed, is housed in a battery case 1 together with an electrolyte. An opening part of the battery case 1 is sealed by a sealing plate 2 through a gasket 3. A positive electrode lead 4a attached to the positive electrode 4 is connected to the sealing plate 2 serving also as a positive electrode terminal. A negative electrode lead 5a attached to the negative electrode 5 is connected to the battery case 1 serving also as a negative electrode terminal.

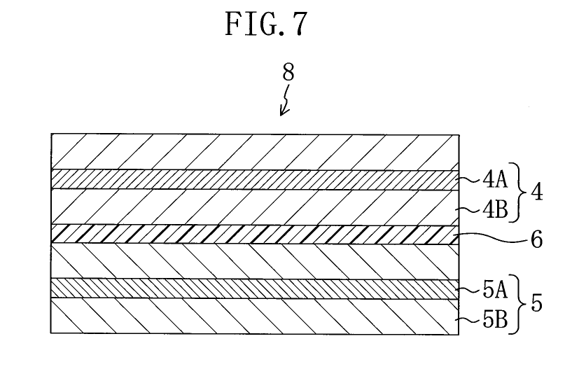

FIG. 7 is an enlarged cross-sectional view schematically showing a configuration of the electrode group 8 in the present example embodiment.

As shown in FIG. 7, positive electrode material mixture layers 4B are formed on the opposite surfaces of a positive electrode current collector 4A. Negative electrode material mixture layers 5A are formed on the opposite surfaces of a negative electrode current collector 5B. The porous insulating layer 6 is interposed between the positive electrode 4 and the negative electrode 5. The positive electrode 4 in the present example embodiment will be described in detail below.

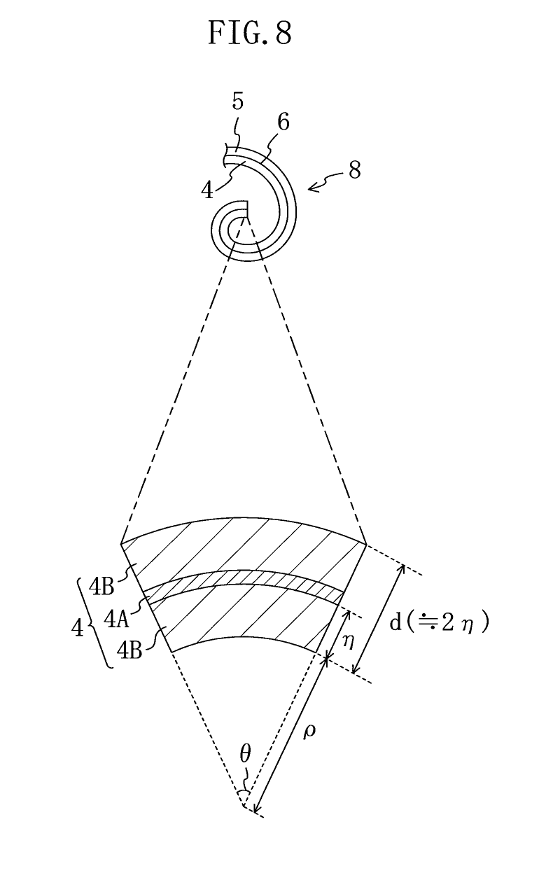

FIG. 8 is a cross-sectional view for explaining η and ρ in the present example embodiment. To meet a recent demand for high-capacity nonaqueous electrolyte secondary batteries, in the positive electrode 4 on the present example embodiment, the loading density of a positive electrode active material on the positive electrode material mixture layers 4B is higher than that of the conventional positive electrode active material, and is 3.7 g/cc or higher, for example. Accordingly, the porosity of the positive electrode material mixture layers 4B is lower than that of the conventional positive electrode material mixture layers, and is 20% or lower, for example. For this reason, the positive electrode material mixture layers 4B are harder than the conventional positive electrode material mixture layers. However, since the tensile extension c in the winding direction of the positive electrode 4 satisfies

ε≧η/ρ (Expression 7),

the electrode group 8 can be fabricated without breaking the positive electrode 4.

Here, η in Expression 7 is a thickness of an inside positive electrode material mixture layer 4B, as shown in FIG. 8. In the case where the positive electrode material mixture layers 4B having the same thickness are formed on the surfaces of the positive electrode current collector 4A, because the thickness of the positive electrode current collector 4A is sufficiently thin relative to the thickness of the positive electrode material mixture layers 4B, η can be set to ½ of the thickness d of the positive electrode 4 (d is nearly equal to 2η). In addition, ρ in Expression 7 is a minimum radius of curvature of the positive electrode 4, as shown in FIG. 8, and is a radius of curvature of a part of the inside positive electrode material mixture layer 4B forming the innermost surface of the electrode group 8.

When such the positive electrode 4 is pulled in the winding direction, the positive electrode current collector 4A is extended, while minute cracks 9 occur in the positive electrode material mixture layers 4B, as shown in FIG. 4(b). In this way, in the positive electrode 4, even after a first crack occurs, the positive electrode current collector 4A continues to be extended for a while without being broken, while cracks occurs in the positive electrode material mixture layers 4B, rather than breakage of the positive electrode current collector 4A at the same time when a large crack occurs in a positive electrode material mixture layer 4B.

The positive electrode 4 in the present example embodiment will be describe below in comparison with the conventional positive electrode 44.

The porosity of the conventional positive electrode material mixture layers 44B is around 30%. Accordingly, as described with reference to FIGS. 2(b) and 3(a), the inside positive electrode material mixture layer 44B contracts in the thickness direction of the positive electrode 44 in winding. Therefore, even when the tensile extension in the winding direction of the positive electrode 44 does not satisfy Expression 7, an electrode group of wound type can be fabricated without breaking the positive electrode current collector 44A. Thus, an electrode group of wound type can be fabricated without breaking the positive electrode current collector 44A even if the positive electrode current collector 44A of the conventional positive electrode 44 extends in the winding direction not so much.

On the other hand, the porosity of the positive electrode material mixture layers 4B in the present example embodiment is 20% or lower. Accordingly, as described with reference to FIGS. 2(b) and 3(b), the inside positive electrode material mixture layer 4B contracts little in the thickness direction of the positive electrode 4 in winding.

Assuming that the inside positive electrode material mixture layer 4B does not contract at all in the thickness direction of the positive electrode 4 by winding the positive electrode 4, the positive electrode current collector 4A would be broken at the innermost surface of the electrode group 8 unless the positive electrode current collector 4A extends longer by η/ρ than the inside positive electrode material mixture layer 4B (according to Expression 3 and Expression 4). However, the tensile extension E of the positive electrode 4 in the present example embodiment satisfies Expression 7, thereby enabling fabrication of the electrode group 8 without breaking the positive electrode current collector 4A. Consequently, the electrode group 8 can be fabricated without breaking the positive electrode current collector 4A even though the porosity of the positive electrode material mixture layers 4B is 20% or lower.

When η and ρ of current nonaqueous electrolyte secondary batteries are taken into consideration, the tensile extension ε of the positive electrode 4 in the present example embodiment may be 2% or higher, but is preferably 10% or lower. When the tensile extension in the winding direction of the positive electrode 4 exceeds 10%, the positive electrode 4 may be deformed in winding the positive electrode 4. It is noted that the tensile extension of the conventional positive electrode 44 is around 1.5%.

Further, when the tensile extension ε in the winding direction of the positive electrode 4 is 3% or higher, in other words, when the positive electrode has a tensile extension E in its winding direction to the same extent as that of the negative electrode and that of the porous insulating layer (the tensile extensions of negative electrodes and porous insulating layers are 3% or higher in many cases), buckling of the electrode group and breakage of the electrode plates, which can be caused by expansion and contraction of the negative electrode active material accompanied by charge/discharge of the battery, can be prevented, besides the advantage that the electrode group 8 can be fabricated without breaking the positive electrode current collector 4A. In addition, an internal short circuit in the battery, which may be caused by crash, can be prevented from occurring.

The former advantage will be described in detail. When the tensile extension in the winding direction of the positive electrode is 3% or higher, the positive electrode and the negative electrode can have almost the same tensile extension in the winding direction. Accordingly, the positive electrode can expand and contract in the winding direction along with expansion and contraction of the negative electrode active material, thereby reducing a stress.

The latter advantage will be described next in detail. When the tensile extension in the winding direction of the positive electrode is 3% or higher, the positive electrode, the negative electrode, and the porous insulating layer can have almost the same tensile extension in the winding direction. This can prevent the positive electrode from being broken first and piercing the porous insulating layer even upon deformation by crash of the nonaqueous electrolyte secondary battery.

Furthermore, in the positive electrode 4 in the present example embodiment, it is preferable that the ratio of the volume that the conductive agent occupies in the positive electrode material mixture layers 4B to the volume that the positive electrode active material occupies in the positive electrode material mixture layers 4B (hereinafter referred to simply as “occupied volume ratio of the conductive agent in the positive electrode material mixture layers 4B”) is equal to or higher than 1% and equal to or lower than 6%. This can suppress a reduction in cycle characteristic with no decrease in battery capacity accompanied even when the porosity of the positive electrode material mixture layers 4B is 20% or lower.

Specifically, the present inventors further examined the phenomena caused by the reduction in porosity of positive electrode material mixture layers, and found that the reduction in porosity of positive electrode material mixture layers reduces the cycle characteristic of nonaqueous electrolyte secondary batteries in some cases. The present inventors considered the reason thereof as follows.

Reduction in porosity of the positive electrode material mixture layers reduces the contact resistance in the positive electrode active material to allow electrons to tend to travel in the positive electrode material mixture layers. This promotes extraction of lithium ions from the positive electrode active material. Here, if the negative electrode active material can sufficiently accept the lithium ions even when the extraction speed of the lithium ions from the positive electrode active material is increased, charge can be performed with no reduction in cycle characteristic accompanied. However, unless the negative electrode active material can sufficiently accept the lithium ions in association with the increased extraction speed of the lithium ions from the positive electrode active material, lithium ions not accepted by the negative electrode active material are deposited as metal on the surface of the negative electrode. As a result, the cycle characteristic is reduced.

However, in the positive electrode 4 in the present example embodiment, the occupied volume ratio of the conductive agent in the positive electrode material mixture layers 4B is equal to or higher than 1% and equal to or lower than 6%. Therefore, even when the porosity of the positive electrode material mixture layers 4B is 20% or lower, a decrease in contact resistance in the positive electrode active material of the positive electrode material mixture layers 4B can be suppressed, thereby suppressing a reduction in cycle characteristic caused by the reduction in porosity of the positive electrode material mixture layers 4B.

The above positive electrode 4 can be fabricated by the positive electrode fabricating method disclosed in the description of the aforementioned application. Specifically, positive electrode material mixture slurry containing a positive electrode active material is first applied on the opposite surfaces of a positive electrode current collector, and is dried (process (a)). Next, the positive electrode current collector having the surfaces on which the positive electrode active material is provided is rolled (process (b)), and is then subjected to heat treatment at a temperature higher than the softening temperature of the positive electrode current collector (process (c)).

As the temperature of the heat treatment after rolling is higher, or the time period of the heat treatment after rolling is longer, the tensile extension in the winding direction of the positive electrode 4 can be increased. Accordingly, the temperature and time period of the heat treatment after rolling may be set so that the tensile extension in the winding direction of the positive electrode 4 becomes a desired value. However, excessively high temperature of the heat treatment after rolling may melt, and in turn dissolve the binder and the like contained in the positive electrode material mixture layers, thereby reducing the performance of the nonaqueous electrolyte secondary battery. On the other hand, excessively longer time period of the heat treatment after rolling may cause the binder and the like melted in the heat treatment after rolling to cover the surface of the positive electrode active material, thereby decreasing the battery capacity. In view of them, it is preferable that the temperature of the heat treatment after rolling is equal to or higher than the softening temperature of the positive electrode current collector and lower than the decomposition temperature of the binder contained in the positive electrode material mixture layers. Further, when the positive electrode current collector 4A is formed with a current collector of 8021 aluminum alloy containing iron of 1.4 weight % or more with respect to aluminum, the temperature of the heat treatment after rolling can be set within a range equal to or higher than the softening temperature (e.g., 160° C.) of the positive electrode current collector and lower than the melting temperature (e.g., 180° C.) of the binder contained in the positive electrode material mixture layers. This can prevent the binder contained in the positive electrode material mixture layers from being melted in the heat treatment after rolling. In this case, the time period of the heat treatment after rolling may be one second or longer, and is preferably set with productivity of the nonaqueous electrolyte secondary battery taken into consideration. Alternatively, in the case where the positive electrode current collector 4A is formed with a current collector of 8021 aluminum alloy, the time period of the heat treatment can be set to 0.1 seconds or longer and one minute or shorter if the temperature of the heat treatment is set equal to or higher than the softening temperature of the positive electrode current collector and lower than the decomposition temperature (e.g., 350° C.) of the binder contained in the positive electrode material mixture layers.

The heat treatment after rolling may be heat treatment using hot air, IH (Induction

Heating), infrared, or electric heat. Among all, it is preferable to select a method in which a hot roll heated to the predetermined temperature (a temperature equal to or higher than the softening temperature of the positive electrode current collector) comes into contact with the rolled positive electrode current collector. Heat treatment after rolling using such a hot roll can reduce the time period of the heat treatment, and can suppress energy loss to a minimum.

As described above, in the nonaqueous electrolyte secondary battery according to the present example embodiment, since the loading density of the positive electrode active material of the positive electrode material mixture layers 4B is higher than that of a conventional positive electrode active material, the battery capacity can be increased. Further, in the nonaqueous electrolyte secondary battery according to the present example embodiment, since the tensile extension ε in the winding direction of the positive electrode 4 satisfies Expression 7, breakage of the positive electrode current collector 4A in winding can be suppressed. Thus, a high-capacity nonaqueous electrolyte secondary battery can be fabricated at a high yield rate.

In the nonaqueous electrolyte secondary battery in the present example embodiment, the occupied volume ratio of the conductive agent in the positive electrode material mixture layers is 1 vol % or higher and 6 vol % or lower. This can suppress a reduction in cycle characteristic in association with the reduction in porosity of the positive electrode material mixture layer 4B.

The present inventors confirmed the advantages of the nonaqueous electrolyte secondary battery according to the present example embodiment by using cylindrical batteries fabricated in accordance with the below mentioned methods. Though not described in detail, the present inventors also carried out a similar experiment on rectangular batteries including electrode groups of wound type for confirming the advantages of the nonaqueous electrolyte secondary battery according to the present example embodiment.

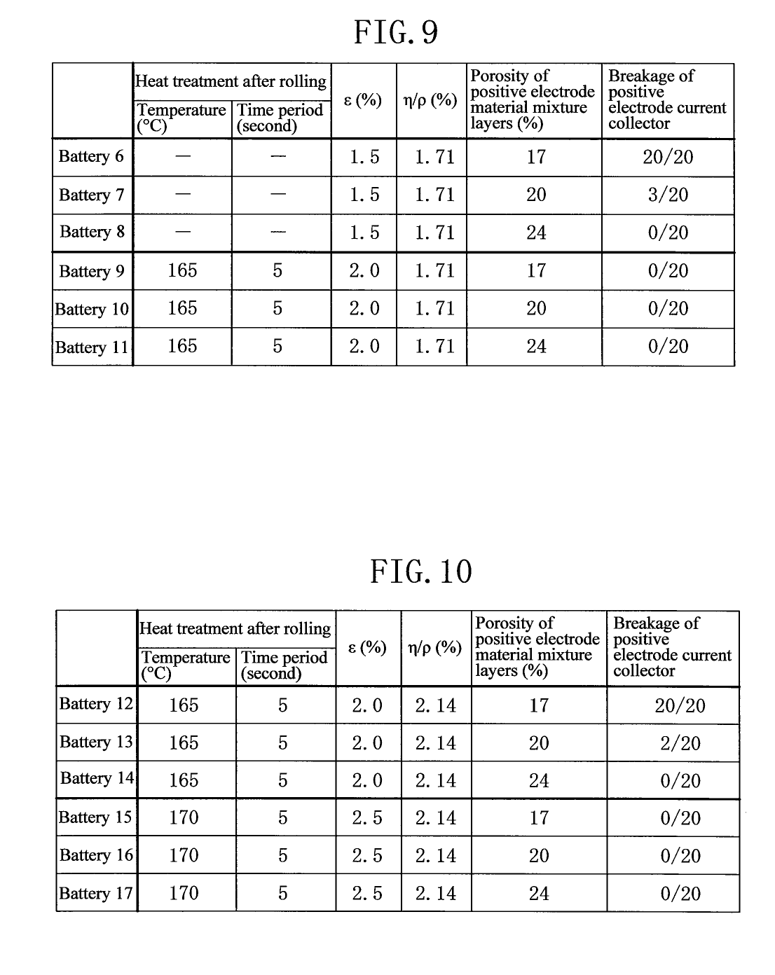

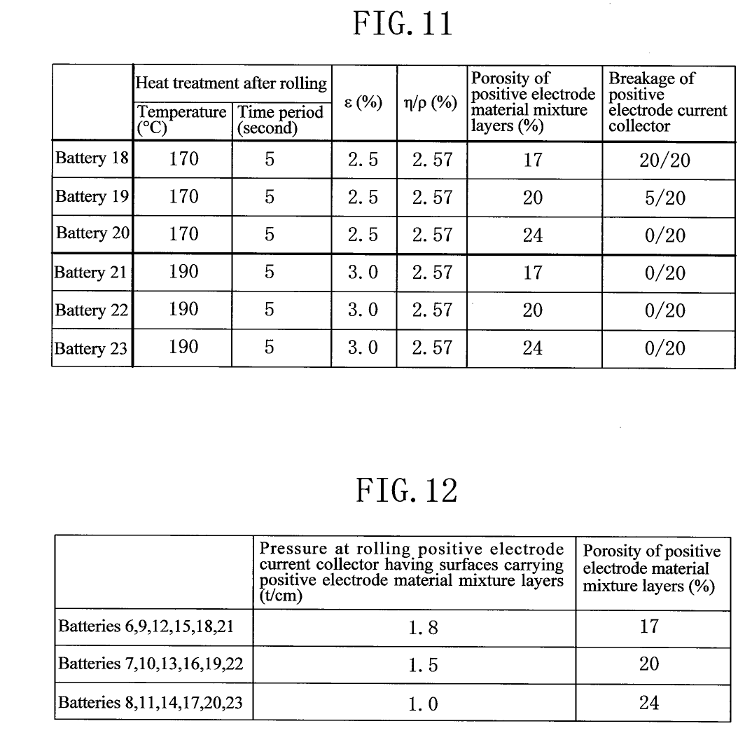

First, it was conformed that, when the tensile extension ε in the winding direction of the positive electrode 4 satisfies Expression 7, the electrode group 8 can be fabricated without breaking the positive electrode current collector 4A. The experiment for and result of the confirmation are shown. FIGS. 9 to 11 are tables showing the results obtained by checking how easily positive electrode current collectors are broken with the tensile extension in the winding direction of the positive electrode varied. FIG. 9 shows the result where η/ρ=1.71 (%). FIG. 10 shows the result where η/ρ=2.14 (%). FIG. 11 shows the result where η/ρ=2.57 (%). FIG. 12 is a table showing a relationship between the pressure at rolling and the porosity of the positive electrode material mixture layers.

In currently available nonaqueous electrolyte secondary batteries, 2η is 0.12 mm, 0.15 mm, or 0.18 mm, and ρ is 3.5 mm or larger. Accordingly, η/ρ can be

η/ρ=(0.12/2)/3.5·100=1.71 (%),

η/ρ=(0.15/2)/3.5·100=2.14 (%), and

η/ρ=(0.18/2)/3.5·100=2.57 (%).

In view of this, the present inventors fabricated Batteries 6 to 23 indicated in FIGS. 9 to 11, and checked whether the positive electrode current collectors were broken by viewing. Description will be given below to a method for fabricating Battery 9 as a typical example of methods for fabricating Batteries 6 to 23.

—Method for Fabricating Battery 9—

(Fabrication of Positive Electrode)

First, 4.5 vol % acetylene black (a conducive agent), a solution in which 4.7 vol % poly(vinylidene fluoride (PVDF) (a binder) is dissolved in a solvent of N-methylpyrrolidone (NMP), and 100 vol % LiNi_{0.82}Co_{0.15}Al_{0.03}O₂ having an average grain size of 10 μm (a positive electrode active material) were mixed, thereby obtaining positive electrode material mixture slurry.

Next, the positive electrode material mixture slurry was applied onto the opposite surfaces of aluminum alloy foil, BESPA FS115 (A8021H-H18), produced by SUMIKEI ALUMINUM FOIL, Co., Ltd., having a thickness of 15 μm, and was dried. Then, a positive electrode current collector having the opposites surfaces on which the positive electrode active material is provided was rolled with a pressure of 1.8 t/cm applied. By doing so, layers containing the positive electrode active material were formed on the opposite surfaces of the positive electrode current collector. At this time point, the porosity of the layers was 17%, and the thickness of the electrode plate was 0.12 mm. Thereafter, the electrode plate come into contact with a hot roll (produced by TOKUDEN CO., LTD.) heated to 165° C. Then, the electrode plate was cut to have a predetermined dimension, thereby obtaining a positive electrode.

(Fabrication of Negative Electrode)

First, flake artificial graphite was crashed and classified to have an average grain size of approximately 20 μm.

Next, one weight part styrene-butadiene rubber (a binder) and 100 weight part aqueous solution containing 1 wt % carboxymethyl cellulose were added to and mixed with the flake artificial graphite of 100 weight part, thereby obtaining negative electrode material mixture slurry.

Subsequently, the negative electrode material mixture slurry was applied onto the opposite surfaces of copper foil (a negative electrode current collector) having a thickness of 8 μm, and was dried. Then, the negative electrode current collector having the opposite surfaces on which the negative electrode active material is provided was rolled, and was subjected to heat treatment at a temperature of 190° C. for five hours. Then, it was cut to have a thickness of 0.210 mm, a width of 58.5 mm, and a length of 510 mm, thereby obtaining a negative electrode.

(Preparation of Nonaqueous Electrolyte)

To a mixed solvent of ethylene carbonate, ethylmethyl carbonate, and dimethyl carboneate at a volume ratio of 1:1:8, 3 wt % vinylene carbonate was added. To the resultant solution, LiPF₆ was dissolved at a concentration of 1.4 mol/m³, thereby obtaining a nonaqueous electrolyte.

(Fabrication of Cylindrical Battery)

First, a positive electrode lead made of aluminum was attached to a part of the positive electrode current collector where the positive electrode material mixture layers are not formed, and a negative electrode lead made of nickel was attached to a part of the negative electrode current collector where the negative electrode material mixture layers are not formed. Then, the positive electrode and the negative electrode face to each other so that the positive electrode lead and the negative electrode lead extend in the opposite directions. Then, a separator (a porous insulating layer) made of polyethylene was placed between the positive electrode and the negative electrode. Next, the positive electrode and the negative electrode between which the separator is placed was wound to a core having a diameter of 3.5 mm with a load of 1.2 kg applied. Thus, a cylindrical electrode group of wound type was fabricated.

Next, an upper insulating plate was placed above the upper surface of the electrode group, and a lower insulating plate was placed below the lower surface of the electrode group. Then, the negative electrode lead was welded to a battery case, and the positive electrode lead was welded to a sealing plate. Next, the electrode group was housed in the battery case. Subsequently, the nonaqueous electrolyte was poured into the battery case under reduced pressure, and the sealing plate was calked to the opening part of the battery case through a gasket. Thus, Battery 9 was fabricated.

—Fabrication of Batteries Other than Battery 9 (Batteries 6 to 8 and 10 to 23)—

Except the fabrication of positive electrodes, Batteries 6 to 8 and 10 to 23 were fabricated in accordance with the method for fabricating Battery 9.

Regarding the heat treatment after rolling, the positive electrodes of Batteries 6 to 8 were not subjected to the heat treatment after rolling, while those of Batteries 10 to 23 were subjected to heat treatment at temperatures for time periods indicated in FIGS. 9 to 11 after rolling.

The pressures in rolling are as indicated in FIG. 12.

The results are shown in FIGS. 9 to 11. In “Breakage of positive electrode current collector” in FIGS. 9 to 11, each numerator of the fractions is the total number of electrode groups, and the denominators thereof are the numbers of electrode groups in which the positive electrode current collectors were broken.

The results of Batteries 6, 7, 9, and 10 prove that, where the porosity of the positive electrode material mixture layers is 20% or lower, the positive electrode current collector is broken in winding unless the tensile extension E in the winding direction of the positive electrode satisfies Expression 7.

The results of Batteries 12, 13, 15, and 16 prove and the results of Batteries 18, 19, 21, and 22 prove that, where the porosity of the positive electrode material mixture layers is 20% or lower, the positive electrode current collector is broken in winding unless the tensile extension e in the winding direction of the positive electrode satisfies Expression 7. In addition, they show that, even where the tensile extension ε in the winding direction of the positive electrode is larger than that of the conventional positive electrode (ε>1.5%), the positive electrode current collector is broken in winding unless the tensile extension in the winding direction of the positive electrode satisfies Expression 7.

The results of Batteries 8, 11, 14, 17, 20, and 23 prove that, where the porosity of the positive electrode material mixture layers exceeds 20%, an electrode group of wound type can be fabricated without breaking the positive electrode current collector even if the tensile extension ε does not satisfy Expression 7 (i.e., even when ε<η/ρ).

Thus, it was confirmed that, as long as the tensile extension ε in the winding direction of a positive electrode satisfies Expression 7, in other words, if the conditions (the temperature and the time period) of the heat treatment after rolling are set so that the tensile extension ε in the winding direction of a positive electrode satisfies Expression 7, an electrode group can be fabricated without breaking a positive electrode current collector even with positive electrode material mixture layers having a porosity of 20% or lower.

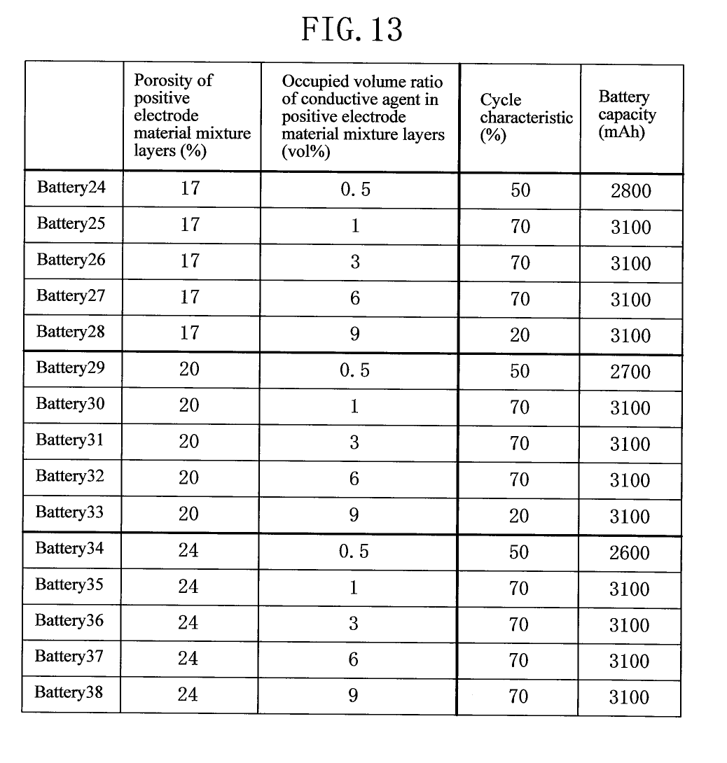

Details and results of an experiment are shown which was carried out for confirming that optimization of the volume that the conductive agent occupies in the positive electrode material mixture layers can suppress a reduction in cycle characteristic. FIG. 13 is a table showing results where the cycle characteristics and the battery capacities are measured with the occupied volume ratio of the conductive agent in the positive electrode material mixture layers varied.

Batteries 24 to 28 indicated in FIG. 13 were fabricated in accordance with the method for fabricating Battery 15 except that the amount of the conductive agent was varied so that the occupied volume ratio of the conductive agent in the positive electrode material mixture layers is varied to the values indicated in FIG. 13. Batteries 29 to 33 were fabricated in accordance with the method for fabricating Battery 16 except that the amount of the conductive agent was varied so that the occupied volume ratio of the conductive agent in the positive electrode material mixture layers was varied to the values indicated in FIG. 13. Batteries 34 to 38 were fabricated in accordance with the method for fabricating Battery 17 except that the amount of the conductive agent was changed so that the occupied volume ratio of the conductive agent in the positive electrode material mixture layers was varied to the values indicated in FIG. 13. Thereafter, the battery capacities of Batteries 24 to 38 were measured, and their cycle characteristics were evaluated. Under an environment at a temperature of 25° C., after charge at a constant current of 1.5 A was performed up to 4.2 V and charge at a constant voltage of 4.2 V was performed until the current value became 50 mA, discharge at a constant current of 0.6 A was performed up to 2.5 V. The battery capacities were capacities at the time. The cycle characteristic is a ratio of a discharge capacity when the following charge/discharge cycle is performed 500 times with respect to a discharge capacity when the charge/discharge cycle is performed one time. The charge/discharge cycle is a cycle in which charge at a constant current of 0.5 CA up to 4.2 V, charge at a constant voltage of 4.2 V up to a current value of 0.1 CA, and then discharge at a constant current of 1 CA up to 2.5 V are performed.

The results of the cycle characteristic will be discussed first. As shown in FIG. 13, the results of Batteries 24, 28, 29, 33, 34, and 38 show that 0.5 vol % and 9 vol % occupied volume ratios of the conductive agent in the positive electrode material mixture layers reduce the cycle characteristic. Further, this reduction is remarkable when the occupied volume ratio of the conductive agent in the positive electrode material mixture layers is 9 vol % (Batteries 28, 33, and 38) when compared with the case where the occupied volume ratio of the conductive agent in the positive electrode material mixture layers is 0.5 vol % (Batteries 24, 29, and 34). Regarding these results, the present inventors consider as follows.

Where the occupied volume ratio of the conductive agent in the positive electrode material mixture layers is 0.5 vol %, repetition of charge/discharge reduces the conductivity in the positive electrode active material because of the content of the conductive agent being too small. It is noted that repetition of charge/discharge degraded the positive electrode in this case, and therefore, the cycle characteristic reduced a little.

On the other hand, where the occupied volume ratio of the conductive agent in the positive electrode material mixture layers is 9 vol %, the porosity of the positive electrode material mixture layers reduces to cause lithium ions, which are not accepted by the negative electrode active material among lithium ions extracted from the positive electrode active material, to deposit on the surfaces of the negative electrode as metal. This degraded the negative electrode. Hence, the cycle characteristic might reduce significantly.

Next, the results of the battery capacities will be described. As shown in FIG. 13, the results of Batteries 24, 29, and 34 show that, where the occupied volume ratio of the conductive agent in the positive electrode material mixture layers is 0.5 vol %, the battery capacity is small. One of the reasons might be that the conductive agent is too small.

As such, it was conformed that, when the occupied volume ratio of the conductive agent in the positive electrode material mixture layers is 1 vol % or higher and 6 vol % or lower, a reduction in cycle characteristic can be suppressed with no decrease in battery capacity accompanied, even if the porosity of the positive electrode material mixture layers is 20% or lower.

The materials for the positive electrode 4, the negative electrode 5, the porous insulating layer 6, and the nonaqueous electrolyte in the present example embodiment are not limited to the aforementioned materials, and may be materials known as materials for positive electrodes, negative electrodes, porous insulating films, and nonaqueous electrolytes of nonaqueous electrolyte secondary batteries, respectively. Respective typical materials will be listed below.

The positive electrode current collector 4A may be a base plate made of aluminum, stainless steel, titanium, and the like, for example. A plurality of holes may be formed in the base plate. In the case where the main material of the positive electrode current collector 4A is aluminum, it is preferable that the positive electrode current collector 4A contains iron of 1.2 wt % or more and 1.7 wt % or less with respect to the aluminum. This can increase, even when heat treatment after rolling is performed at a low temperature for a short time period, the tensile extension ε in the winding direction of the positive electrode 4 when compared with the case where the positive electrode current collector is made of 1085 aluminum foil, IN30 aluminum foil, or 3003 aluminum foil. Accordingly, This can suppress covering of the positive electrode active material by the binder melted in the heat treatment after rolling, the binder being contained in the positive electrode material mixture layers 4B. Therefore, the battery capacity can be prevented from decreasing, besides the advantage that the electrode group 8 of wound type can be fabricated without breaking the positive electrode current collector 4A.

The positive electrode material mixture layers 4B may contain a binder, a conductive agent, and the like, in addition to the positive electrode active material. The positive electrode active material may be lithium composite metal oxide, for example. Typical examples of the materials include LiCoO₂, LiNiO₂, LiMnO₂, LiCoNiO₂, and the like. As the binder, PVDF, derivatives of PVDF, rubber-based binders (e.g., fluoro rubbers, acrylic rubbers, etc.), and the like may be used favorably, for example. As the conductive agent, materials of graphite, such as black lead and the like, carbon black, such as acetylene black and the like may be employed, for example.

It is preferable that the ratio of the volume that the binder occupies in the positive electrode material mixture layers 4B is 1% or higher and 6% or lower with respect to the volume that the positive electrode active material occupies in the positive electrode material mixture layers 4B. This can suppress to a minimum the area where the binder melted in the heat treatment after rolling covers the positive electrode active material, thereby preventing a decrease in battery capacity in association with the heat treatment after rolling. In addition, since the ratio of the volume that the binder occupies in the positive electrode material mixture layers 4B with respect to the volume that the positive electrode active material occupies in the positive electrode material mixture layers 4B is 1% or higher, the positive electrode active material can be bonded to the positive electrode current collector.

The volume ratio of the conductive agent in the positive electrode material mixture layers 4B is as above, and the method for fabricating the positive electrode 4 is as above.

The negative electrode current collector 5A may be a base plate made of copper, stainless copper, nickel, and the like, for example. A plurality of holes may be formed in the base plate.

The negative electrode material mixture layers 5B may contain a binder and the like in addition to the negative electrode active material. The negative electrode active material may be made of carbon materials, such as black lead, carbon fiber, and the like, silicon compounds, such as SiOₓ, and the like.

The negative electrode 5 thus configured is fabricated in the following manner, for example. First, negative electrode material mixture slurry containing the negative electrode active material, a binder, and the like is prepared, is applied onto the opposite surfaces of the negative electrode current collector 5A, and is then dried. Next, the negative electrode current collector having the surfaces of which the negative electrode active material is provided is rolled. After the rolling, heat treatment may be performed at a predetermined temperature for a predetermined time period.

The porous insulating layer 6 may be microporous thin films, woven fabric, nonwoven fabric, and the like having high ion permeability, predetermined mechanical strength, and predetermined insulating property. Particularly, it is preferable that the porous insulating layer 6 is made of polyolefin, such as polypropylene, polyethylene, and the like, for example. Polyolefin, which is excellent in durability and has a shutdown function, can increase safety of a nonaqueous electrolyte secondary battery. In the case where a microporous thin film is used as the porous insulating layer 6, the microporous thin film may be a single-layer film made of one kind of material, or a composite or multi-layer film made of two or more kinds of materials.

The nonaqueous electrolyte contains an electrolyte and a nonaqueous solvent dissolved therein.

Any known nonaqueous solvents can be used as the nonaqueous solvent. Although the kinds of the nonaqueous solvent are not limited specifically, cyclic carbonate ester, chain carbonate ester, cyclic carboxylic ester, or the like may be used solely. Alternatively, a combination of two or more of them may be used.

The electrolyte may be any one or a combination of two or more of LiClO₄, LiBF₄, LiPF₆, LiAlCl₄, LiSbF₆, LiSCN, LiCF₃SO₃, LiCF₃CO₂, LiAsF₆, LiB₁₀Cl₁₀, low aliphatic lithium carboxylate, LiCl, LiBr, LiI, lithium chloroborane, borates, imide salts, and the like. The amount of the electrolyte dissolving in the nonaqueous solvent is preferably 0.5 mol/m³ or more and 2 mol/m³ or less.

Besides the electrolyte and the nonaqueous solvent, the nonaqueous electrolyte may contain an additive having a function of increasing charge/discharge efficiency of a battery in a manner that it decomposes on a negative electrode to form on the negative electrode a film having high lithium ion conductivity. As an additive having such a function, a single or a combination of two or more of vinylene carbonate (VC), vinyl ethylene carbonate (VEC), divynyl ethylene carbonate, and the like may be employed, for example.

Further, the nonaqueous electrolyte may contain, in addition to the electrolyte and the nonaqueous solvent, a known benzene derivative that inactivates a battery in a manner that it decomposes at overcharge to form a film on an electrode. Preferably, the benzene derivative having such a function has a phenyl group and a cyclic compound group next to the phenyl group. The content ratio of the benzene derivative to the nonaqueous solvent is preferably 10 vol % or lower of the total amount of the nonaqueous solvent.

One example of methods for fabricating a nonaqueous electrolyte secondary battery may be the method described in the above mentioned subtitle, “-Method for fabricating Battery 9-.”

The present invention has been described by referring to preferred example embodiments, which do not serve as limitations, and various modifications are possible, of course. For example, the above example embodiments describe a cylindrical lithium ion secondary battery as a nonaqueous electrolyte secondary battery, but can be applied to other nonaqueous electrolyte secondary batteries, such as rectangular lithium ion secondary batteries, nickel hydrogen storage batteries, and the like including electrode groups of wound type. The present invention can exhibit the advantage that breakage of the positive electrode current collector in winding in association with a reduction in porosity of the positive electrode material mixture layers can be prevented. In addition, when the tensile extension in the winding direction of the positive electrode is 3% or higher, the present invention can prevent of buckling of the electrode group and breakage of the electrode plate caused by expansion and contraction of the negative electrode active material in association with charge/discharge of the battery. Additionally, the present invention can prevent occurrence of an internal short circuit in a battery caused by crash.

### INDUSTRIAL APPLICABILITY

As described above, the present invention is useful in nonaqueous electrolyte secondary batteries including electrode groups suitable for large current discharge, and is applicable to drive batteries for electric tools and electric vehicles requiring high power output, large capacity batteries for backup power supply and for storage power supply.

1. A nonaqueous electrolyte secondary battery, comprising:
an electrode group including a positive electrode in which a positive electrode material mixture layer is provided on a positive electrode current collector, a negative electrode in which a negative electrode material mixture layer is provided on a negative electrode current collector, and a porous insulating film, where the positive electrode and the negative electrode are wound with the porous insulating layer interposed,
wherein the positive electrode material mixture layer is provided on at least one of opposite surfaces of the positive electrode current collector located inside in a radial direction of the electrode group,
the positive electrode material mixture layer has a porosity of 20% or lower, and
ε≧η/ρ is satisfied where η is a thickness of the positive electrode material mixture layer provided on the surface located inside in the radial direction of the electrode group of the surfaces of the positive electrode current collector, ρ is a minimum radius of curvature of the positive electrode, and ε is a tensile extension in a winding direction of the positive electrode.

2. The battery of claim 1,
wherein the minimum radius p of curvature of the positive electrode is a radius of curvature of a part of the positive electrode material mixture layer forming an innermost surface of the electrode group.

3. The battery of claim 1,
wherein the tensile extension E in the winding direction of the positive electrode is equal to or higher than 2%.

4. The battery of claim 1,
wherein the positive electrode is obtained by applying onto a surface of the positive electrode current collector and drying positive electrode material mixture slurry containing a positive electrode active material and then performing heat treatment after rolling on the positive electrode current collector having the surface on which the positive electrode active material is provided.

5. The battery of claim 4,
wherein the positive electrode current collector is made of aluminum containing iron.

6. The battery of claim 1,
wherein the positive electrode material mixture layer contains a positive electrode active material and a conductive agent, and
a ratio of a volume that the conductive agent occupies in the positive electrode material mixture layer to a volume that the positive electrode active material occupies in the positive electrode material mixture layer is equal to or higher than 1% and equal to or lower than 6%.

7. A method for fabricating the nonaqueous electrolyte secondary battery of claim 1, wherein the positive electrode is fabricated by
(a) applying onto a surface of the positive electrode current collector electrode material mixture slurry containing a positive electrode active material, and then drying it;
(b) rolling the positive electrode current collector having the surface on which the positive electrode active material is provided; and
(c) performing, after (b), heat treatment on the rolled positive electrode current collector at a temperature equal to or higher than a softening temperature of the positive electrode current collector.
